(19) United States
(12) Patent Application Publication
(10) Pub. No.: US 2017/0284623 A1
(43) Pub. Date: Oct. 5, 2017

(54) METHODS AND APPARATUS FOR FREE-FORM ILLUMINATION ASSEMBLIES

(71) Applicant: GM GLOBAL TECHNOLOGY OPERATIONS LLC, Detroit, MI (US)

(72) Inventors: CANDICE M. WILLETT, COMMERCE TOWNSHIP, MI (US); YOUNG SUN KIM, CANTON, MI (US); THOMAS D. MORAN, KIMBALL, MI (US)

(73) Assignee: GM GLOBAL TECHNOLOGY OPERATIONS LLC, Detroit, MI (US)

(21) Appl. No.: 15/086,894

(22) Filed: Mar. 31, 2016

(51) Int. Cl. F21S 8/10

(52) U.S. Cl. CPC F21S 48/225; F21S 48/215; F21S 48/217; F21Y 2115/10

(57) ABSTRACT

An illumination assembly for a mobile platform includes a body structure and a light source. The body structure is three-dimensional and at least partially transparent. The light source, which is substantially encapsulated within the body structure and is non-planar, is configured to selectably illuminate at least a portion of the body structure in response to an activation signal produced external to the body structure.

### TECHNICAL FIELD

The technical field generally relates to lighting structures. More particularly, the technical field relates to illumination assemblies and other lighting components used in the context of mobile platforms, such as automobiles and the like.

### BACKGROUND

Mobile platforms such as automotive vehicles, marine vessels, and aircraft use illumination assemblies for a variety of purposes, such as illuminating the mobile platform's path and/or providing an indicator related to the operation of the mobile platform. Such illumination assemblies may function, for example, as front lighting (daytime running lamps, parking lamps, turn signals), rear lighting (braking indicators, tail lamps, turn signals) and/or accent lighting.

Recent advances in lighting technology, such as the wide availability of highly- efficient light-emitting diode (LED) components, have resulted in illumination assemblies that are less expensive, more reliable, and lighter than traditional lighting. Nevertheless, such illumination assemblies may be unsatisfactory in a number of respects. For example, such assemblies may require a large number of components, e.g., a light source arranged adjacent to one or more transparent or translucent structures, one or more light guides, one or more reflectors, one or more carriers (e.g., LED carriers), various textured or diffusion regions configured to scatter incoming light, etc. Furthermore, such lighting assemblies often include light sources that are strictly planar, preventing the creation of freeform, three-dimensional structures that might provide enhanced functionality while improving the assembly's aesthetic appeal.

Referring briefly to FIG. 3, for example, a light source 302 illuminates one edge (the leftmost edge in the drawing) of a light-transmitting structure 304, producing illumination (indicated by the arrows as shown). Such an embodiment requires heavy texturing and light guides to ensure uniform lighting conditions, resulting in an uneven appearance in an inactivated state. FIG. 4 depicts another example in which the light source 402 uses a mirror or other light-redirection component to light the structure 404. It will be appreciated that such an embodiment would also require a large number of structural components and would exhibit many of the downsides of the embodiment of FIG. 3. FIG. 5 depicts a case in which the light source 502 is strictly planar and is coupled to (e.g., laminated to) structure 504. Such an embodiment restricts the range of designs to planar or substantially non-3D shapes.

Accordingly, it is desirable to provide illumination assemblies that have a reduced component-count and which can be formed into arbitrary, three-dimensional structures. Other desirable features and characteristics of the present invention will become apparent from the subsequent detailed description and the appended claims, taken in conjunction with the accompanying drawings and the foregoing technical field and background.

### SUMMARY

In accordance with one embodiment, an illumination assembly for a mobile platform includes a body structure and a light source. The body structure is three- dimensional and at least partially transparent. The light source, which is substantially encapsulated within the body structure, is non-planar and configured to selectably illuminate at least a portion of the body structure in response to an activation signal produced external to the body structure.

In accordance with one embodiment, a method for forming a lighting structure for a mobile platform includes: providing a substantially non-planar light source; forming a three-dimensional body structure such that the light source is substantially encapsulated within the body structure, the body structure being at least partially transparent; and forming an interconnect extending from outside the body structure to the light source such that the light source is configured to selectably illuminate at least a portion of the body structure in response to an activation signal received via the interconnect.

### DESCRIPTION OF THE DRAWINGS

The exemplary embodiments will hereinafter be described in conjunction with the following drawing figures, wherein like numerals denote like elements, and wherein:

FIG. 1 is conceptual isometric view of an illumination assembly in accordance with one embodiment;

FIG. 2 is a conceptual side view of the illumination assembly of FIG. 1;

FIGS. 3-5 present examples of prior art illumination assemblies;

FIG. 6 is a flow-chart illustrating a method of forming an illumination assembly in accordance with one embodiment;

FIGS. 7-10 present sequential side views of an example lay-up process used for forming an illumination assembly in accordance with one embodiment;

FIG. 11 illustrates a mobile platform (i.e., an automotive vehicle) in accordance with one embodiment;

FIG. 12 illustrates an illumination assembly in the form of a braking indicator for use with the mobile platform illustrated in FIG. 11.

### DETAILED DESCRIPTION

In general, the subject matter described herein relates to improved, three-dimensional or “free-form” illumination assemblies that require fewer components and have an improved aesthetic appeal. In that regard, there is no intention to be bound by any expressed or implied theory presented in the preceding technical field, background, brief summary or the following detailed description. As used herein, the term module or control refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices.

In addition, those skilled in the art will appreciate that embodiments of the present disclosure may be practiced in conjunction with any number of systems, and that the illumination assemblies described herein are merely various exemplary embodiments of the present disclosure. For the sake of brevity, conventional techniques related to lighting systems, light color, lighting interconnects, LEDs, automotive lighting systems, signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

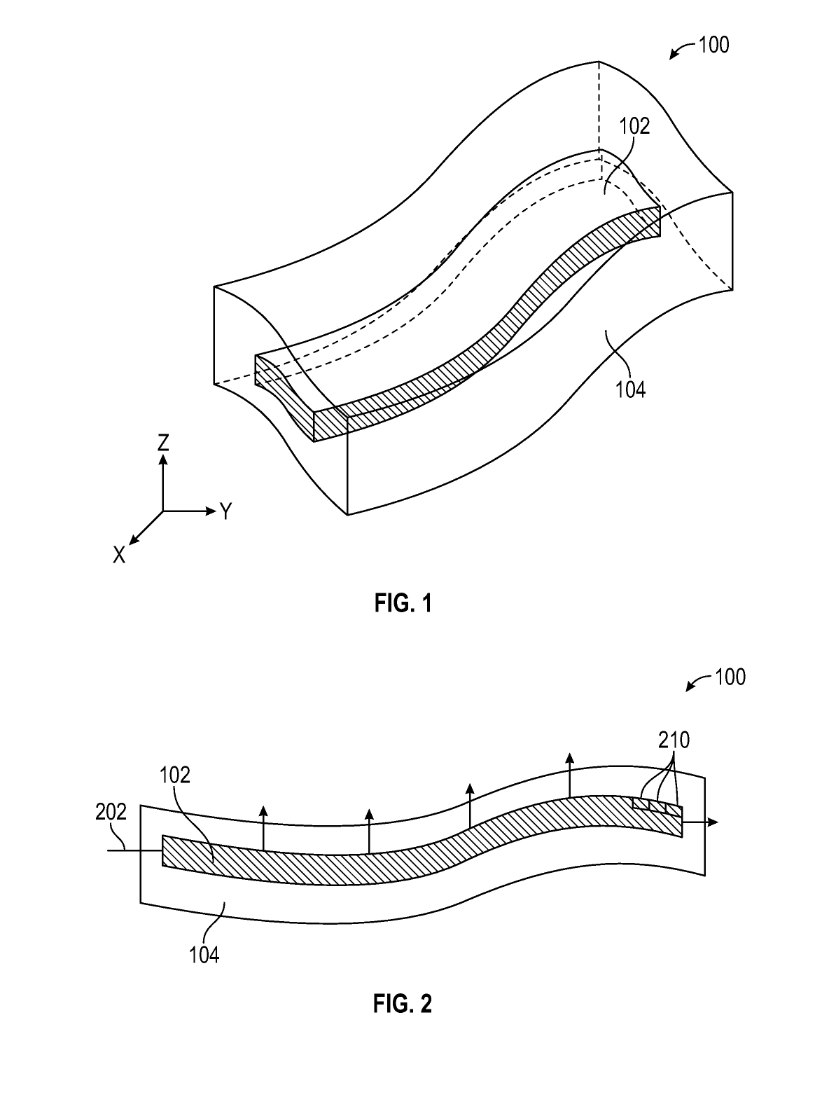

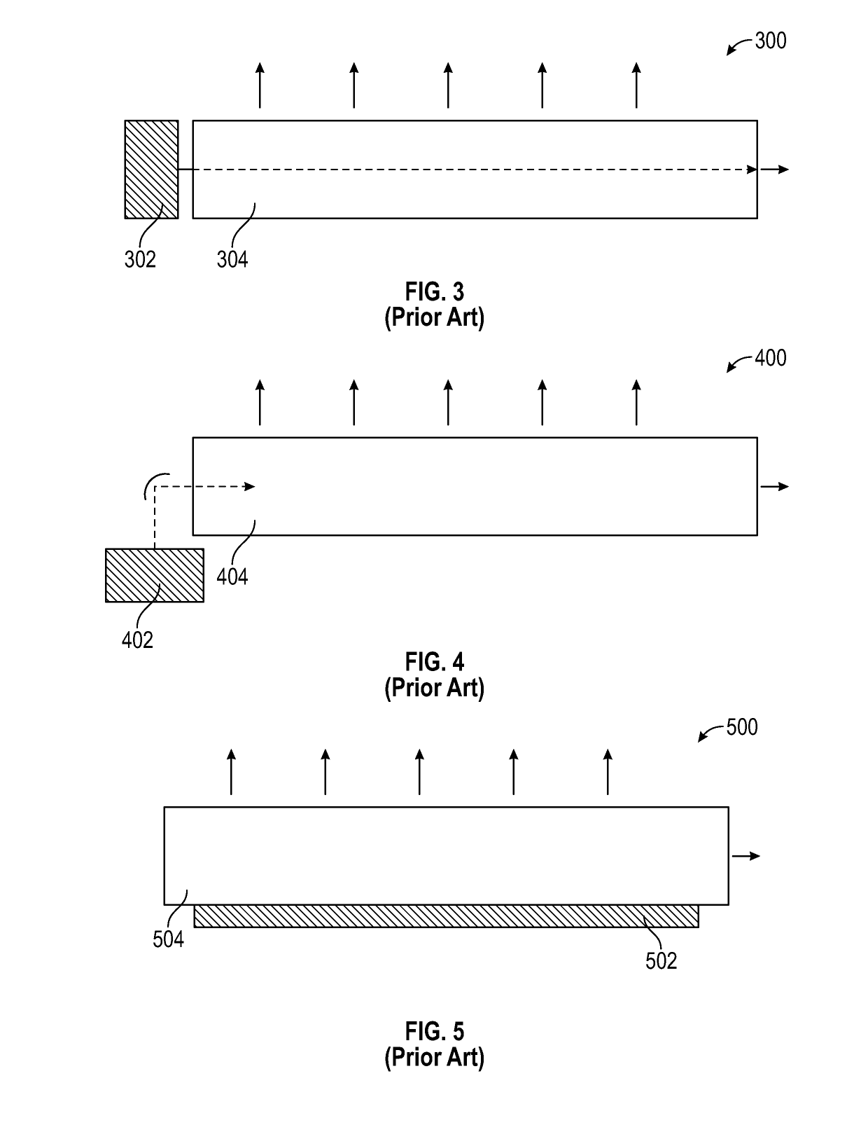

FIG. 1 is conceptual isometric view of an illumination assembly 100 in accordance with one embodiment, and FIG. 2 is a conceptual side view of the illumination assembly 100 of FIG. 1. As a preliminary matter, the scale, sizes, and shapes of the various components shown in these figures are provided for illustrative purposes only, and are not intended to be limiting in any respect.

Furthermore, while the illumination assembly 100 may be discussed in the context of automotive vehicles (e.g., as a braking indicator for an automotive vehicle), such examples are used without loss of generality, and thus the range of possible embodiments and mobile platforms are not so limited. The phrase “mobile platform” as used herein refers to any structure that is configured to move through its environment, such as an automotive vehicle, an aircraft, a robotic platform, a water-going vessel, or any other such mobile platform now known or later developed.

In general, illumination assembly 100 includes a body structure 104 and a light source 102 substantially encapsulated within body structure 104, as shown. Light source 102 is communicatively coupled to a lighting control module or other such controller 205 via an electrical interconnect 202 (e.g., a communication bus, one or more conductive wires, or the like) as shown in FIG. 2.

Light source 102 is “substantially encapsulated within” body structure 104 in that all or nearly all of its volume is surrounded and falls within the boundary of body structure 104. In some embodiments, as shown in FIG. 1, light source 102 is fully encapsulated within body structure 104. In other embodiments, an edge or other portion may extend to the boundary of body structure 104, thus providing an “edge lighting” effect.

In various embodiments, body structure 104 is three-dimensional and at least partially transparent. As used herein, the phrase “three-dimensional” (or simply “3D”) as used in connection with a structural component (e.g., body structure 104 and/or light source 102) generally refers to an object that occupies volume in three spatial dimensions. The phrase “free-form” may also be used herein to refer to 3D objects and to denote the fact that the object may have an arbitrary, desired shape (i.e., not limited to a strictly 2D or planar structure). That is, a 2D “manifold” as that term is used in the art (e.g., a thin sheet of material that is sufficiently thin that it appears two-dimensional, but which can be molded or otherwise formed to occupy a three-dimensional space) could be considered a “3D” structural component in some embodiments.

Light source 102 includes any component or group of components that can serve as a source of illumination, producing light at least partially within the human optical range. Such light sources may be selectably activated (e.g., either in an on-off or a continuously variable mode) through modulation of a suitable power source communicatively coupled to the light source. Example light sources include light-emitting diodes—such as Organic Light-Emitting Diodes (OLEDs), traditional white light-emitting diodes (WLEDs)—incandescent light sources, fluorescent light sources, electroluminescent light sources, and the like. Such light sources may have any desirable color (e.g., “color temperature”), depending upon the desired application, and are not limited to light sources that produce substantially white light. In some embodiments, light source 102 is implemented as a single component. In others, light source 102 is implemented as an array of components, such as an array of light-emitting diodes 210 as shown in FIG. 2.

Body structure 104 is “at least partially transparent” in the sense that it is not strictly opaque in its entirety. That is, body structure 104 transmits a human-observable level of light of any arbitrary color. For example, in the context of a mobile platform consisting of an automotive vehicle, body structure 104 might be formed as a translucent red component. In other embodiments, body structure 104 may be substantially clear (i.e., not modifying the color of the light produced by light source 102), green, blue, or any other color or combination of colors required for a given application. In some embodiments, body structure 104 is multi-colored. In others, it includes some limited opaque regions.

Body structure 104 may be formed from any suitably material that is transparent to semi-transparent and allows some transmission of light. In one embodiment, body structure 104 comprises a translucent polycarbonate, such as LEXAN polycarbonate.

In various embodiments, light source 102 is non-planar and configured to selectably illuminate at least a portion of body structure 104 in response to an activation signal (e.g., an on-off signal, a dimming signal, or the like) produced external to the body structure, for example, via lighting control module 205 and interconnect 202. The arrows in FIG. 2 illustrate such illumination, wherein the light produced via light source 102 extends toward the outer boundary of body structure 104 (e.g., at surfaces 206, 207, and 208). It will be appreciated that additional components, such as light guides, diffused regions, and the like, may also be incorporated into body structure 104 to provide the desired lighting pattern and effect.

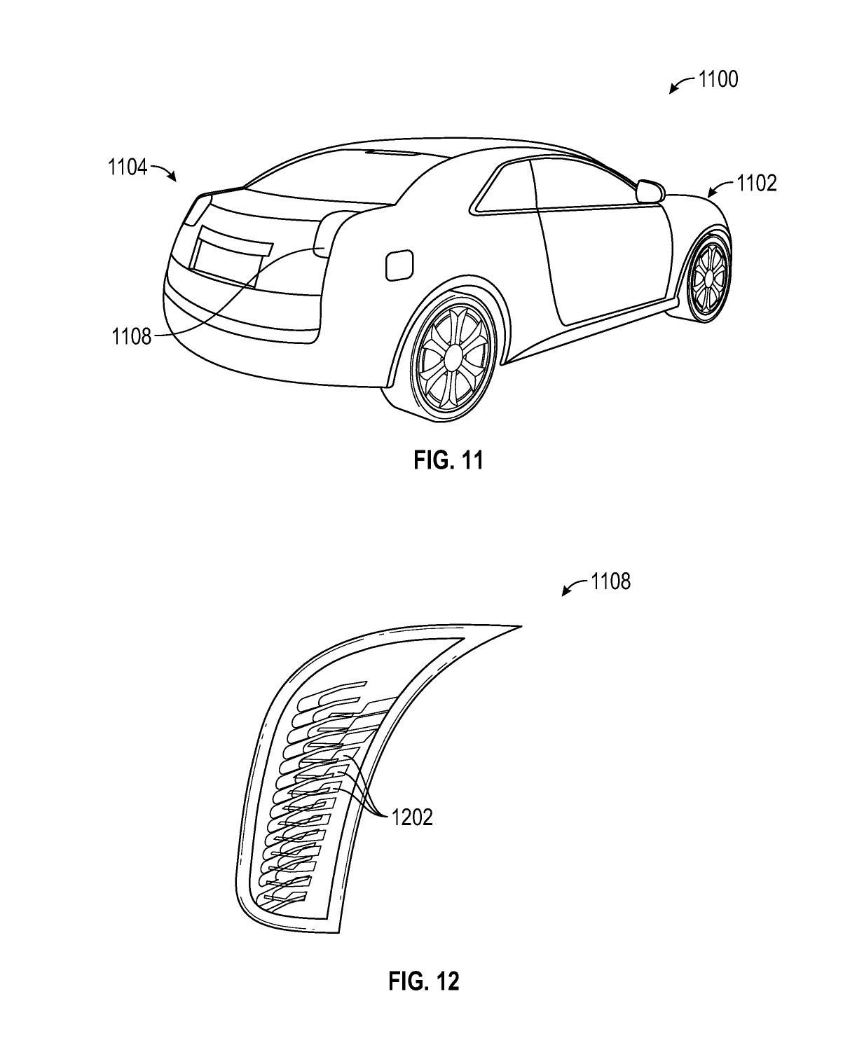

In one embodiment, the mobile platform is an automotive vehicle and the braking indicator is a rear brake indicator for the automotive vehicle. Such an embodiment is shown in FIG. 11, which illustrates a mobile platform 1100 implemented as an automotive vehicle. Mobile platform 1100 includes a rear (or “aft”) portion 1104 having a brake indicator 1108 provided therein. As will be understood, a turn-signal indicator may also be incorporated into the structure provided by brake indicator 1108.

FIG. 12 illustrates one embodiment of the brake indicator 1108 of FIG. 11. As shown, brake indicator 1108 includes a body structure 1201 and a light source 1202 that comprises a series of substantially parallel laminar sections, as shown. That is, while some regions of light source 1202 may be locally planar to some degree, light source 1202 as a whole is three-dimensional.

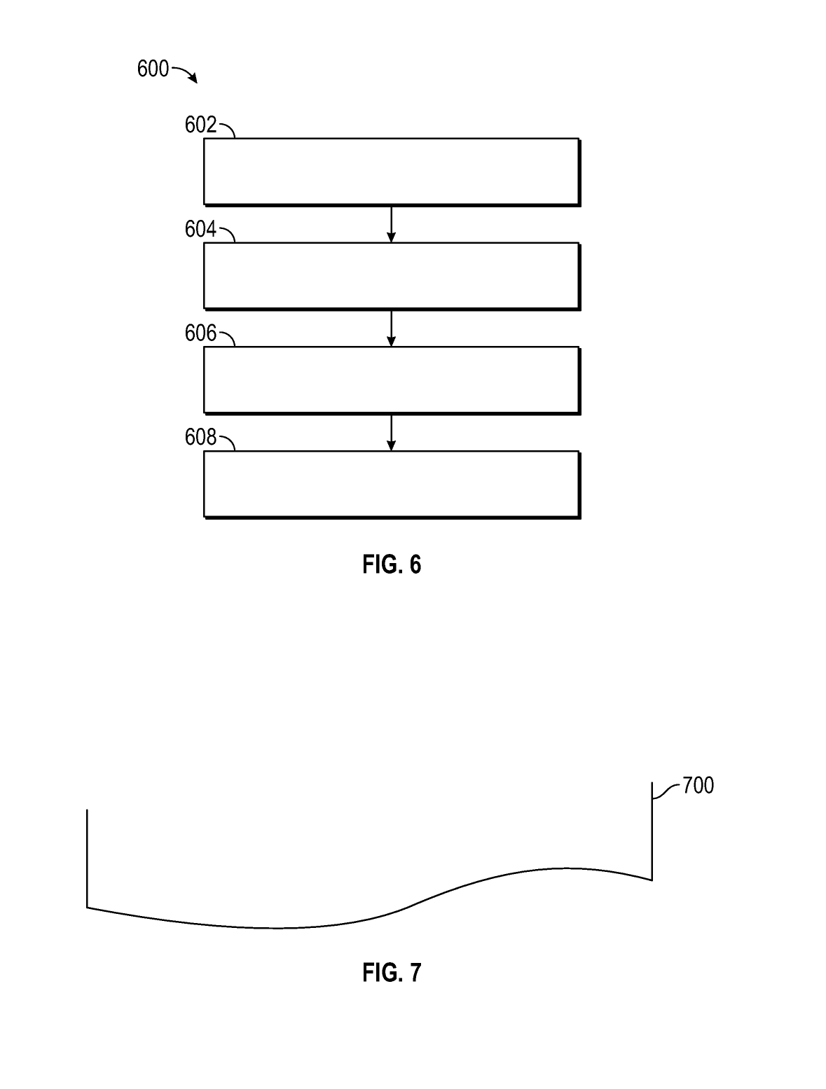

Having thus described an illumination assembly 100 in accordance with various embodiments, a method of forming a lighting structure for a mobile platform will now be described in conjunction with the flow-chart 600 of FIG. 6 as well as the example shown in FIGS. 1 and 2.

Initially, a substantially non-planar light source 102 is provided (block 602). As mentioned above, light source 102 may include any component or group of components that can serve as a source of illumination, producing light at least partially within the human optical range. In some embodiments, light source 102 comprises a single LED or an array of LEDs, such as an array of OLED that may be formed or deformed to a three-dimensional shape.

Next, at block 604, a three-dimensional body structure 104 is formed such that the light source 102 is substantially encapsulated within body structure 104. As mentioned above, body structure 104 may be formed from any suitable transparent or substantially transparent material, such as a polycarbonate material. Body structure 104 may be formed utilizing a variety of plastic-forming techniques known in the art, as described in further detail below.

At block 606, an interconnect 202 is formed from outside body structure 104 to the light source 102 such that light source 102 is configured to selectably illuminate at least a portion of the body structure in response to an activation signal received via the interconnect 202. In some embodiments, interconnect 202 is formed prior to block 604—that is, it may be encapsulated within body structure 104 alone with light source 102. In one embodiment, interconnect 202 comprises electrical leads that are sealed within and through the encapsulation and routed to an external controller.

Finally, at block 608, light control module 205 is communicatively coupled to light source 102 via interconnect 202. This may be performed, for example, during final assembly of the mobile platform. In the case of an automotive vehicle, for example, interconnect 202 may be electrically connected to a bus or other communication network provided within the vehicle.

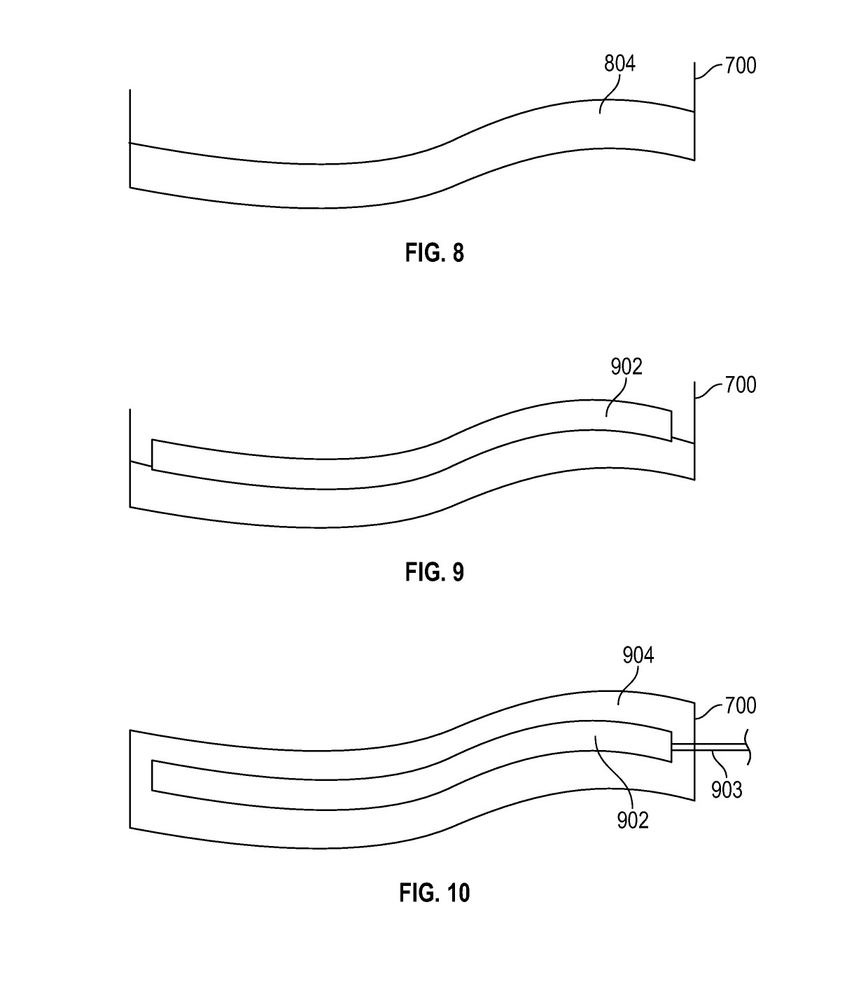

With respect to block 604, the three-dimensional body structure 104 may be created via in-mold layup process. Such a process is illustrated in the sequential side views of FIGS. 7-10. As shown in FIG. 7, a mold 700 is provided. Mold 700 corresponds in part to the contours of the desired body shape. As shown in FIG. 8, a material 804 (i.e., the desired body structure material) is poured or otherwise deposited within mold 700. This is followed by light source 902 being placed on or within material 804 as illustrated in FIG. 9. Finally, as shown in FIG. 10, additional material 904 is poured or otherwise deposited over light source 902 to form a substantially integrated structure. An interconnect 903 is also suitably formed and connected to light source 902, as shown.

In addition to the illustrated lay-up process, other methods for forming the illumination assembly may be utilized. In one embodiment, for example, the light source 102 may be encapsulated within body structure 104 via a welding process. In another embodiment, the light source is substantially encapsulated within the body structure includes a co-injection process. Whether insert-molded, transfer-molded, formed via a lamination process or a secondary two-piece vibration, sonic, laser or hot plate weld process, it is desirable that the assembly be harmonically sealed and encapsulated within the free-form substrate, which creates the 3D appearance.

It will be appreciated systems and methods in accordance with the above can be used to produce an illumination assembly with many benefits. As mentioned briefly in the Background section above, currently known illumination assemblies often require a large number of components and/or often incorporate light sources that are strictly planar, preventing the creation of freeform, 3D structures that might provide enhanced functionality while improving the assembly's aesthetic appeal.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An illumination assembly for a mobile platform, comprising:
a body structure, the body structure being three-dimensional and at least partially transparent; and
a light source substantially encapsulated within the body structure, the light source being non-planar and configured to selectably illuminate at least a portion of the body structure in response to an activation signal produced external to the body structure.

2. The illumination assembly of claim 1, wherein the light source comprises an array of light-emitting diodes.

3. The illumination assembly of claim 2, wherein the light source comprises an array of organic light-emitting diodes.

4. The illumination assembly of claim 1, wherein the body structure and light source are configured as a braking indicator for the mobile platform.

5. The illumination assembly of claim 1, wherein the body structure comprises a translucent polycarbonate.

6. A mobile platform comprising:
a lighting control module; and
an illumination assembly, the illumination assembly including:
a body structure, the body structure being three-dimensional and at least partially transparent; and
a light source substantially encapsulated within the body structure and communicatively coupled to the lighting control module via an electrical interconnect, the light source being non-planar and configured to selectably illuminate at least a portion of the body structure in response to an activation signal received from the lighting control module.

7. The mobile platform of claim 6, wherein the light source comprises an array of light-emitting diodes.

8. The mobile platform of claim 7, wherein the light source comprises an array of organic light-emitting diodes.

9. The mobile platform of claim 6, wherein the body structure and light source are configured as a braking indicator for the mobile platform.

10. The mobile platform of claim 9, wherein the mobile platform is an automotive vehicle and the braking indicator is a rear brake indicator for the automotive vehicle.

11. The mobile platform of claim 6, wherein the mobile platform is an automotive vehicle, and the light source and body structure are configured as a turn indicator for the automotive vehicle.

12. The mobile platform of claim 6, wherein the body structure comprises a translucent polycarbonate.

13. A method for forming a lighting structure for a mobile platform, the method comprising:
providing a substantially non-planar light source;
forming a three-dimensional body structure such that the light source is substantially encapsulated within the body structure, the body structure being at least partially transparent;
forming an interconnect extending from outside the body structure to the light source such that the light source is configured to selectably illuminate at least a portion of the body structure in response to an activation signal received via the interconnect.

14. The method of claim 13, wherein the light source comprises an array of light-emitting diodes.

15. The method of claim 14, wherein the light source comprises an array of organic light-emitting diodes.

16. The method of claim 13, wherein the body structure and light source are formed as a rear lighting indicator for the mobile platform.

17. The method of claim 13, wherein the body structure is formed from a translucent polycarbonate.

18. The method of claim 13, wherein forming the three-dimensional body structure such that the light source is substantially encapsulated within the body structure includes performing an in-mold layup process including the light source.

19. The method of claim 13, wherein forming the three-dimensional body structure such that the light source is substantially encapsulated within the body structure includes performing a welding process.

20. The method of claim 13, wherein forming the three-dimensional body structure such that the light source is substantially encapsulated within the body structure includes a co-injection process.
